(19) United States
(12) Patent Application Publication
(10) Pub. No.: US 2026/0284559 A1
(43) Pub. Date: Sep. 24, 2026

(54) FILTER ELEMENT ENDPLATE ORIENTED ON HEAD IN FILTER

(71) Applicant: Atmus Filtration Inc., Nashville, TN (US)

(72) Inventors: Min XU, Wuhan, Hubei (CN); Meng ZENG, Wuhan, Hubei (CN); Yiyun ZHANG, Shanghai (CN); Qin HU, Wuhan, Hubei (CN)

(21) Appl. No.: 19/480,275

(22) PCT Filed: Jun. 9, 2023
(86) PCT No.: PCT/CN2023/099514

§ 371 Date: Oct. 30, 2025

(51) Int. Cl. B01D 29/15; B01D 35/157

(52) U.S. Cl. CPC B01D 29/15; B01D 35/1573; B01D 2201/295; B01D 2201/304; B01D 2201/347; B01D 2201/4046

(57) ABSTRACT

A filtration system includes a filter head and a filter cartridge. He filter head includes a filter head body defining a valve port and a rib extending away from the filter head body. The filter cartridge includes a filter element and a first endplate coupled to a first end of the filter element. The first endplate includes a first endplate end wall and a valve assembly extending axially away from the endplate end wall and towards the filter head. The valve assembly includes a valve and a valve assembly body defining one or more flow channels. The one or more flow channels enable fluid communication between the valve port and an inner volume of the filtration system via the valve.

### FIELD

The present application relates generally to filtration systems for use in supplying filtered fluids to downstream devices.

### BACKGROUND

Filtration systems may be used to separate contaminates from a fluid to protect downstream devices from damage (e.g., corrosion, clogging, etc.). For example, filtration systems may protect downstream devices by including filter element to separate contaminants form the fluid that may damage the downstream devices. Filtration systems may be primed to reduce an amount of air entrained in the filtration system.

### SUMMARY

Various embodiments provide for a filtration system. A filter head comprises a filter head body defining a valve port, and a rib extending away from the filter head body. A filter cartridge comprises a shell and a filter element coupled to the shell, the filter element comprising a filter media and a first endplate coupled to a first end of the filter media. The first endplate comprises a first endplate end wall and a valve assembly extending axially away from the endplate end wall and towards the filter head. The valve assembly comprises a valve and a valve assembly body defining one or more flow channels. The one or more flow channels enable fluid communication between the valve port and an inner volume of the filtration system via the valve.

Various other embodiments provide for a filter cartridge comprising a shell and a filter element positioned within the shell. The filter element comprises a filter media and a first endplate coupled to a first end of the filter media. The first endplate comprises a first endplate end wall and a valve assembly extending axially away from the endplate end wall and towards the filter head. The valve assembly comprises a valve and a valve assembly body defining one or more flow channels. The one or more flow channels enable fluid communication between the valve port and an inner volume of the filtration system via the valve.

Various other embodiments provide for a method of assembling the filtration system The method comprises aligning a filter cartridge relative to a filter head comprising a filter head body defining a valve port and a rib such that a portion of the filter cartridge contacts the rib. The rib guides the portion of the filter cartridge towards the valve port when the portion of the filter cartridge contacts the rib.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a front view of a filtration system, according to an example embodiment.

FIG. 2 is a sectional view of the filtration system of FIG. 1.

FIG. 3 is a perspective view of the filtration system of FIG. 1, shown in a disassembled state.

FIG. 4 is a top view of a first endplate for use in the filtration system of FIG. 1.

FIG. 5 is a bottom view of the first endplate of FIG. 4.

FIG. 6 is a top view of a second endplate for use in the filtration system of FIG. 1.

FIG. 7 is a bottom view of the second endplate of FIG. 6.

FIG. 8 is a front view of a filter head for use in the filtration system of FIG. 1.

FIG. 9 is a rear view of the filter head of FIG. 8.

FIG. 10 is a perspective view of the filter head of FIG. 8.

FIG. 11 is a side-sectional view of the filter head of FIG. 8.

FIG. 12 is a bottom view of the filter head of FIG. 8.

FIG. 13 is a sectional view of the filtration system of FIG. 1.

### DETAILED DESCRIPTION

Referring to the Figures generally, various embodiments disclosed herein relate to a filtration system. The filtration system advantageously includes an improved filter element and filter head arrangement that may mitigate (e.g., reduce) fluid from flowing backwards through the filtration system during priming. The embodiments shown and described in further detail herein relate to an outside-in flow design for a filtration system. It should be understood that the embodiments described herein may be utilized in other filtration system arrangements. For example, the embodiments described herein may be utilized in an inside-out flow design and/or any other type of filtration systems. Additionally, the filtration system may include more or fewer components than as shown in the Figures. Accordingly, references to various components being within, downstream, exterior, upstream, and the like are relative to the embodiments shown in Figures, and it should be understood that other embodiments, such as an inside-out flow design for a filtration system, may have the same or similar components provided in a different arrangement.

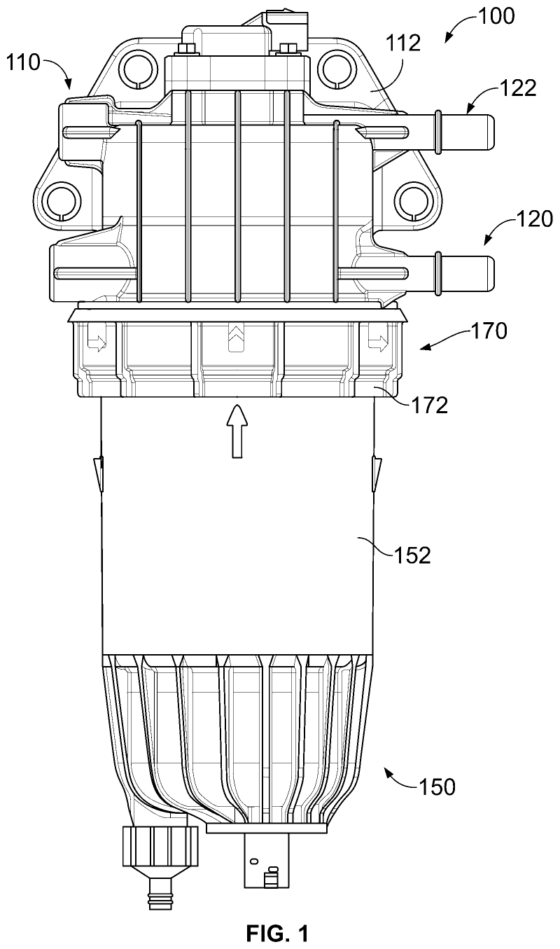

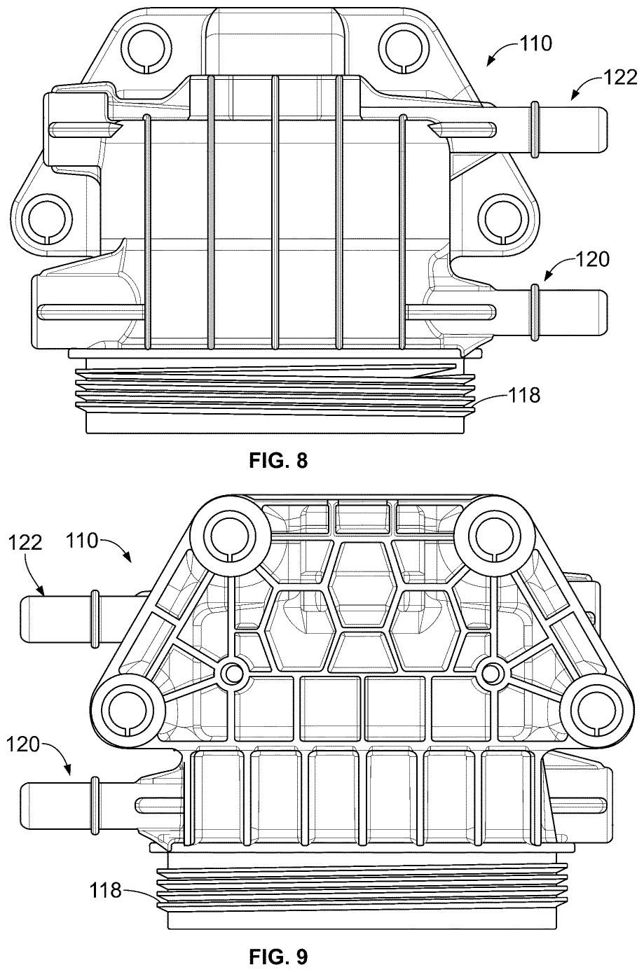

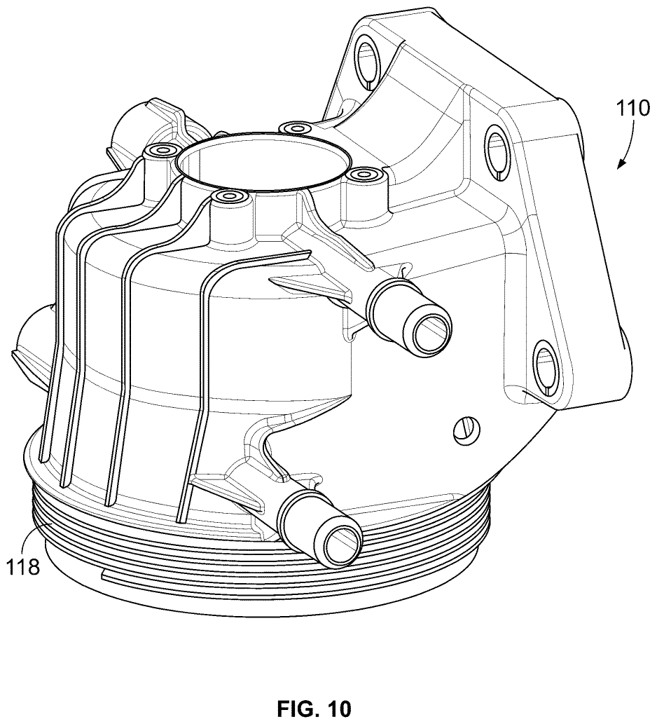

Now referring to FIGS. 1-3, a various views of a filtration system 100 are shown, according to an example embodiment. The filtration system 100 is configured to receive an unfiltered fluid (e.g., fuel, oil, etc.), filter the fluid, and provide the filtered fluid to a downstream device, such as an engine. As shown, the filtration system 100 includes a filter head 110 and a filter cartridge 150. The filter cartridge 150 is configured to be coupled to the filter head 110. Additional views of the filter head 110 are shown in FIGS. 8-12. It should be understood that the filtration system 100 may include more or fewer components than as shown in FIGS. 1-3.

The filter head 110 includes a filter head body 112. The filter head 110 includes a first filter head sealing surface 114. The first filter head sealing surface 114 is defined on an inside surface of the filter head body 112. The first filter head sealing surface 114 is disposed at or directed towards the filter cartridge 150.

The filter head 110 includes a second filter head sealing surface 116. The second filter head sealing surface 116 is defined on an inside surface of the filter head body 112. The second filter head sealing surface 116 is disposed at or directed towards the filter cartridge 150. The second filter head sealing surface 116 is spaced away from the first filter head sealing surface in an axial direction.

The filter head 110 includes one or more filter head threads 118. The one or more filter head threads 118 are disposed on an outside surface of the filter head body 112 and extend away from (e.g., outward from) the filter head body 112.

The filter head 110 includes a radial flange 119 extending outward from the outer surface of the filter head body 112. The radial flange 119 is disposed axially above the one or more filter head threads 118 and axially below the filter head sealing surface 114. The first filter head sealing surface 114 is disposed axially above the radial flange 119. The second filter head sealing surface 116 is disposed axially below the radial flange 119.

The filter head body 112 defines a first port 120 and a second port 122. The first port 120 is an inlet port in fluid receiving communication with an upstream device and in fluid providing communication with an interior of the filtration system 100. The second port 122 is an outlet port in fluid receiving communication with an interior of the filtration system 100 and in fluid providing communication with a downstream device, such as an engine. In some embodiments, the first port 120 may be an outlet port and the second port 122 may be an inlet port.

The filter head body 112 defines a valve port 124. The valve port 124 is in fluid receiving communication with the interior of the filtration system 100 and in fluid providing communication with the second port 122. The valve port 124 defines a valve port sealing surface 126.

The filter head body 112 defines a filter head opening 128. The filter head opening 128 extends through the filter head body 112. The filter head opening 128 is centered on a center axis 129. The center axis 129 extends through a radial center of the filtration system 100, a center of the filter head 110, a center of the filter cartridge 150, and/or a center of the filter element 200.

The filter head 110 includes a rib 130. The rib 130 is disposed on an inside surface of the filter head body 130 and extends axially away from the filter head body 112. The rib 130 is disposed at or directed towards the filter cartridge 150. The rib 130 extends around (e.g., radially outside) the filter head opening 128.

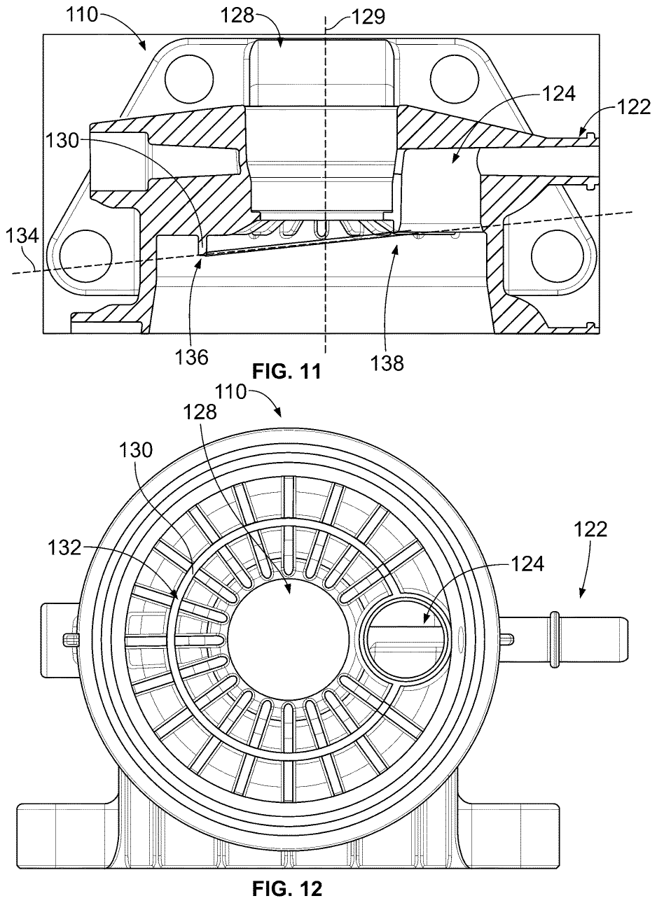

As shown in FIG. 12, the rib 130 has a substantially circular cross-sectional shape. The circular cross-sectional shape of the rib 130 is intersected by the valve port 124. As shown in FIG. 11, a bottom surface 132 of the rib 130 extends along a rib axis 134 that is angled with respect to the center axis 129 at a non-zero angle. The bottom surface 132 of the rib 130 is angled such that a first end 136 of the rib 130 extends further away from the filter head body 112 than a second end 138 of the rib 130. The first end 136 of the rib 130 is disposed opposite the second end 138 of the rib 130. The second end 138 of the rib 130 id disposed proximate the valve port 124. The shape of the rib 130 advantageously guiding surface for the filter cartridge 150 when the filter cartridge is coupled to the filter head.

It should be understood that, in other embodiments, the filter head 110 may have a different design or configuration than as shown in FIG. 1.

The filtration system 100 also includes a pump 140. The pump 140 is disposed within the filter head opening 128. That is, the filter head opening 128 is sided to receive the pump 145 therein. The pump 140 is configured to create a pressure differential within the filtration system 100 thereby drawing fluid in an outside-in flow configuration.

The filter cartridge 150 includes a shell 152 and a filter element 200. The shell 152 at least partially defines an internal volume 154. The filter head 110 at least partially defines the internal volume 154. The filter element 200 is disposed at least partially within the internal volume 154 such that the filter element 200 is within the filter head 110 and the shell 152.

The shell 152 includes a shell wall 156. The shell 152 includes a shell flange 158. The shell flange 157 extends radially outward from the shell wall 156.

The shell 152 includes a first shell sealing surface 160. The first shell sealing surface 160 is disposed at a first end of the shell 150 and is directed towards the filter head 110. The first shell sealing surface 160 is disposed on an outer surface of the shell wall 156 and axially above the shell flange 158. More specifically, the first shell sealing surface 160 is defined by an outer surface of the shell wall 156 and top surface of the shell flange 158.

The shell 152 includes a second shell sealing surface 162. The second shell sealing surface 162 is disposed at a second end of the shell 150, opposite the first end, and is directed towards the filter head 110. The second shell sealing surface 162 is disposed on an inside surface of the shell wall 156.

The filter cartridge 150 includes a first sealing member 164 (e.g., an O-ring, a gasket, etc.). The first sealing member 164 is disposed between the shell 152 and the filter head 110. The first sealing member 164 engages the second filter head sealing surface 116 and the first shell sealing surface 160 and forms a first, radially directed seal therebetween. The first sealing member 164 substantially prevents a fluid from flowing between the filter head 110 and the shell 152 at the second filter head sealing surface 116 and the first shell sealing surface 160.

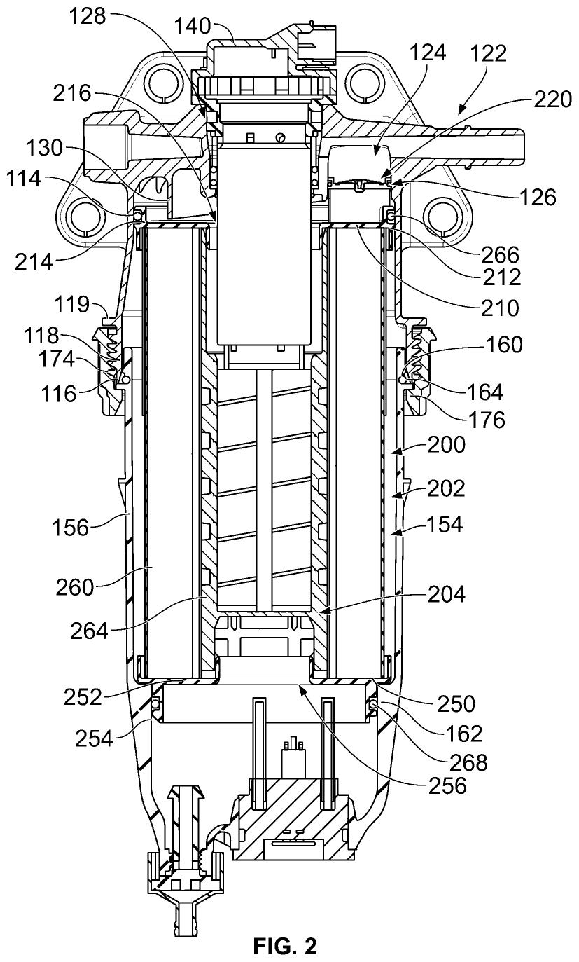

The filtration system 100 includes a collar 170. The collar includes a collar body 172 and one or more collar threads 174. The collar threads 174 are disposed on an inside surface of the collar body 172. The collar threads 174 enable coupling the collar 170 to the filter head 110. As shown in FIG. 2, the collar threads 174 are inward facing threads that are structured to engage the outward facing filter head threads 118.

The collar 170 includes a collar flange 176. The collar flange 176 extends radially inward from the collar body 172. The collar flange 176 contacts and/or engages the shell flange 158 when the collar 170 is coupled to the filter head 110. In this way, the collar 170 couples the filter cartridge 150 to the filter head 110.

The filter element 200 is configured to filter the fluid (e.g., by removing contaminants). In some embodiments, the filter element 200 is removably coupled to the shell 152. In other embodiments, the filter element 200 is permanently secured within the shell 152 such that the filter element 200 cannot be removed from the shell 152 without causing damage to the filter element 200 and/or the shell 152. The filter element 200 is at least partially contained within the shell 152 and/or the filter head 110.

As shown, the filter element 200 includes a first endplate 210, a second endplate 250, a filter media 260, and a center tube 264. The filter element 200 includes a second sealing member 266 (e.g., an O-ring, a gasket, etc.) and a third sealing member 268.

The filter media 260 is positioned between and is coupled to the first endplate 210 and the second endplate 250. The filter media 260 is formed in a cylindrical or annular configuration. The filter media 260 may be pleated to increase surface area. The filter media 260 may be a single-layer media or a multi-layer media made from at least one of a woven fiber, a non-woven material, a wet laid material, a polymeric material, a glass material, a cellulose material, and/or other suitable material. The filter media 260 is structured to allow the unfiltered fluid to be filtered by flowing through the filter media 260. For example, the unfiltered fluid flows through the filter media 260, and the filter media 260 removes impurities, such as particulates, organic matter, and the like, from the unfiltered fluid as the unfiltered fluid passes through the filter media 260. The impurities are trapped by the filter media 260. An outer volume 202 is defined between the filter media 260 and the shell 152. An internal volume 204 is defined within the filter media 260.

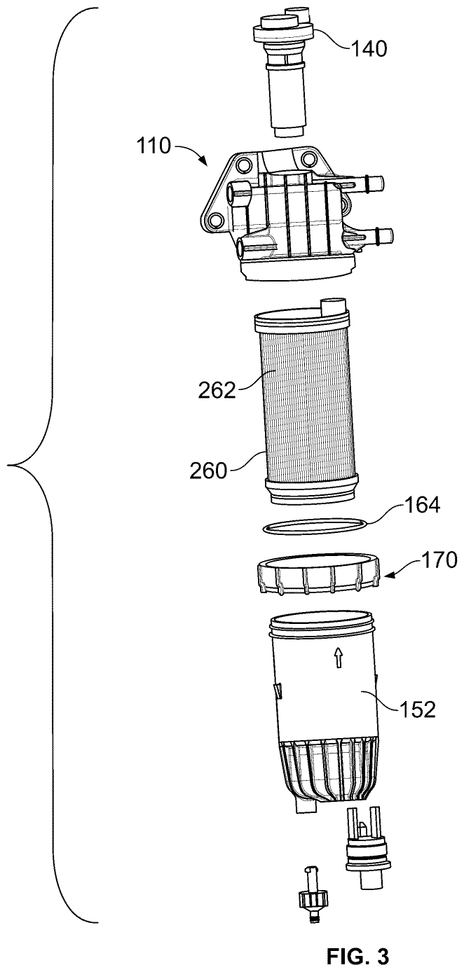

In some embodiments and as shown in FIG. 3, the filter element 200 includes a wrapping layer 262. The wrapping layer 262 is disposed around at least a portion of the filter media 260. The wrapping layer 262 substantially prevents a fluid from flowing therethrough. The wrapping layer 262 is disposed at or proximate the first port 120 such that a fluid entering the filtration system at the first port 120 flows into the outer volume 202 and flows into the wrapping layer 262. In this way, the wrapping layer 262 substantially prevents a fluid from flowing through the filter media 260 when first entering the outer volume 202. Advantageously, the wrapping layer 262 mitigates degradation to the filter media 260 caused by the fluid flowing into the filter media 260.

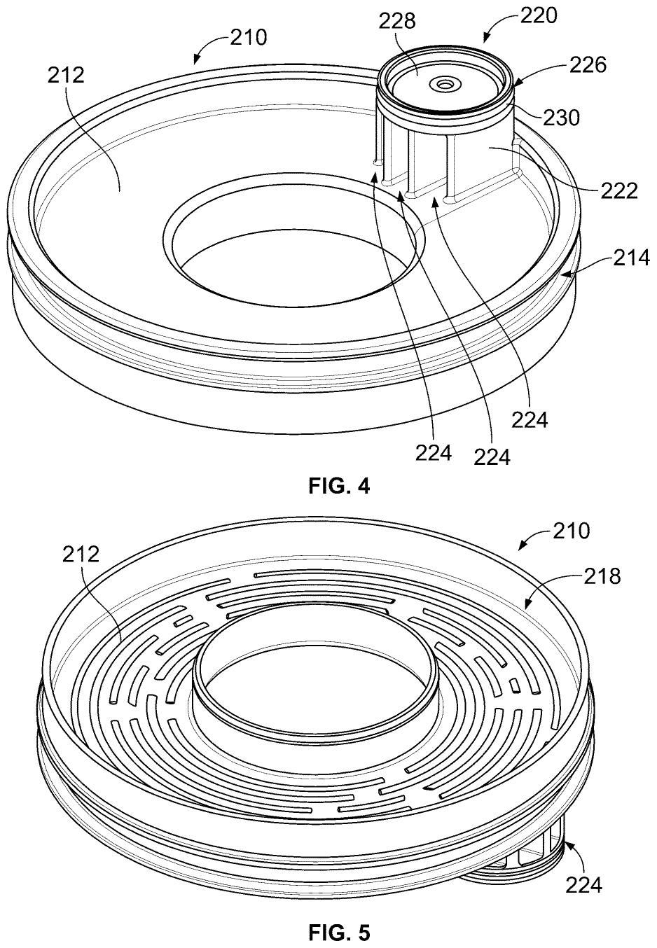

The first endplate 210 is fixedly coupled to the filter media 230. More specifically, the first endplate 210 is coupled to the filter media 230 at a filter media first end. The first endplate 210 includes a first endplate end wall 212 and a first endplate sealing surface 214. Additional views of the first endplate 210 are shown in FIGS. 4 and 5.

The first endplate sealing surface 214 extends axially away from a surface the first endplate end wall 212. More specifically, the first endplate sealing surface 214 extends axially away from a top surface of the first endplate end wall 212. The first endplate sealing surface 214 is disposed at an outer periphery of the first endplate end wall 212 and is directed towards the filter head 110. The first endplate sealing surface 214 is disposed proximate the first filter head sealing surface 114.

As shown in FIG. 2, the first endplate sealing surface 214 is a channel that extends axially away from a top surface of the first endplate end wall 212. The channel defines an open end that is directed radially outwards and towards the filter head 110. The first endplate sealing surface 214 (e.g., the channel) is sized to receive the second sealing member 266. The first endplate sealing surface 214 supports the sealing member 266. The second sealing member 266 engages the first filter head sealing surface 114 and the first endplate sealing surface 214 to form a radially directed seal therebetween. The seal substantially prevents a fluid from flowing between the filter head 110 and the first endplate 210.

The first endplate end wall 212 defines a first opening 216. The first opening 216 is sized to receive at least a portion of the pump 140 therethrough. As shown in FIG. 2, the first opening 216 extends through a center of the first endplate end wall 212 (e.g., centered on the central axis 129). The pump 140 is centered on the central axis 129.

As shown in FIG. 5, the first endplate 210 includes a first channel 218 disposed on a bottom side of the first endplate end wall 212. The first channel 218 is structured to receive a portion of the filter element 260.

The first endplate 210 includes a valve assembly 220. The valve assembly 220 is disposed on a surface of the first endplate end wall 212 and extends axially away from the first endplate end wall 212. The valve assembly 220 is disposed on a first side of the first endplate end wall 212 such that valve assembly 220 is disposed radially away from the first opening 216. That is the valve assembly 220 is radially offset from the center axis 129.

As shown in FIG. 4, the valve assembly 220 includes a valve assembly body 222, a valve assembly sealing surface 226, and a valve 228 (e.g., a check valve, a one way valve, etc.). When the filter cartridge 150 is coupled to the filter head 110, the valve assembly 220 is disposed at least partially within the valve port 124.

The valve assembly body 222 extend axially away from the first endplate end wall 212 and toward the filter head 110. More specifically, the valve assembly body 222 extends toward the valve port 124 such that at least a portion of the valve assembly body 222 is within the valve port 124. The valve assembly body 222 defines one or more flow channels 224. For example, as shown in FIGS. 4 and 5 the valve assembly body 222 includes one or more walls that define the flow channels 224 therebetween. The flow channels 224 enable fluid communication between the internal volume 204 and the valve 228. As shown in FIGS. 4 and 5, the flow channels 224 extend through the valve assembly body 222.

The valve assembly sealing surface 226 extends around a periphery of the valve assembly body 222. The valve assembly sealing surface 226 extends axially away from a top surface of the valve assembly body 222 and is directed towards the valve port 124. The valve assembly sealing surface 226 is disposed proximate the valve port sealing surface 126.

As shown in FIG. 4, the valve assembly sealing surface 226 is a channel that extends axially away from the top surface of the valve assembly body 222. The channel defines an open end that is directed radially outward and towards the valve port 124. The valve assembly sealing surface 226 (e.g., the channel) is sized to receive a fourth sealing member 230. The valve assembly sealing surface 226 supports the fourth sealing member 230. The fourth sealing member 230 engages valve port sealing surface 126 and the valve assembly sealing surface 226 to form a radially directed seal therebetween. The seal substantially prevents a fluid from flowing between the valve assembly 220 and the valve port 124.

The valve 228 is coupled to the valve assembly body 222. The valve 228 selectively enables fluid communication between internal volume 204 and the second port 122. More specifically, the valve 228 selectively enables fluid communication between internal volume 204 and the second port 122 via the flow channels 224 and the valve port 124. In some embodiments, the valve 228 is a check valve or a one-way valve that enables a fluid to flow from the internal volume 204 to the second port 122 and substantially prevents a fluid from flowing from the second port 122 to the internal volume 204. However, it should be understood that, in other embodiments, such as an outside-in flow configuration, the valve 228 may enables a fluid to flow from the second port 122 to the internal volume 204 and substantially prevents a fluid from flowing from the internal volume 204 to the second port 122.

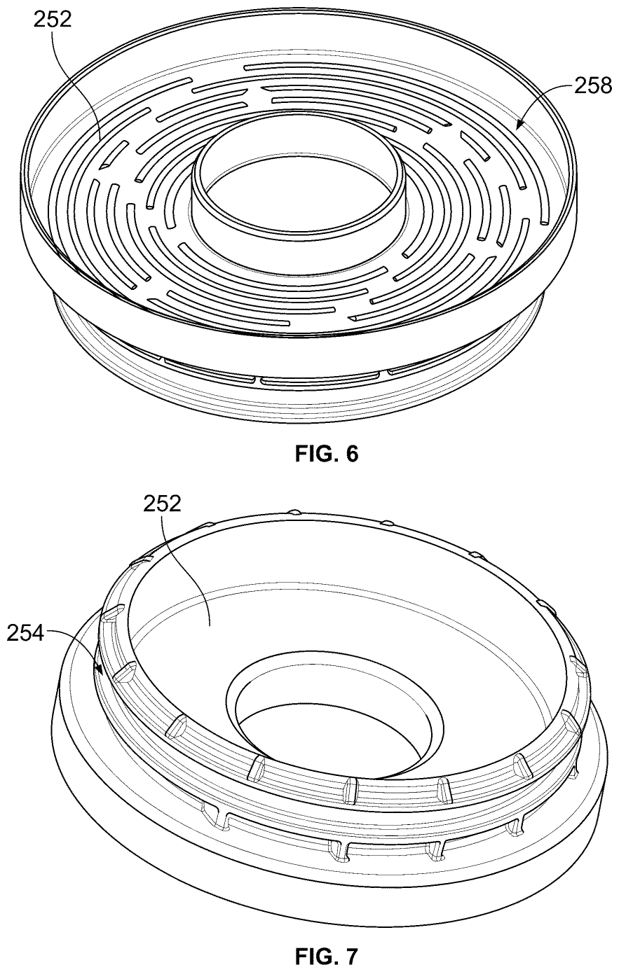

The second endplate 250 is fixedly coupled to the filter media 230. More specifically, the second endplate 250 is coupled to the filter media 230 at a filter media second end, opposite the first end. The second endplate 250 includes a second endplate end wall 252 and a second endplate sealing surface 254. Additional views of the second endplate 250 are shown in FIGS. 6 and 7.

The second endplate sealing surface 254 extends axially away from a surface of the second endplate end wall 252. More specifically, the second endplate sealing surface 254 extends axially away from a bottom surface of the second endplate end wall 252. The second endplate sealing surface 254 is disposed at an outer periphery of the second endplate end wall 252 and is directed towards the shell 152. The second endplate sealing surface 254 is disposed proximate the second shell sealing surface 162.

As shown in FIG. 2, the second endplate sealing surface 254 is a channel that extends axially away from a bottom surface of the second endplate end wall 252. The channel defines an open end that is directed radially outward and towards the shell 152. The second endplate sealing surface 254 (e.g., the channel) is sized to receive the third sealing member 268. The first endplate sealing surface 254 supports the sealing member 268. The third sealing member 268 engages the second shell sealing surface 162 and the second endplate sealing surface 254 to form a radially directed seal therebetween. The seal substantially prevents a fluid from flowing between the shell 152 and the second endplate 250.

The second endplate end wall 252 defines a second opening 256. The second opening 256 enables fluid communication between the internal volume 204 and a bottom portion of the shell 152.

As shown in FIG. 6, the second endplate 250 includes a second channel 258 disposed on a top side of the second endplate end wall 252. The second channel 258 is structured to receive a portion of the filter element 260.

The center tube 264 is positioned within the filter media 260. The center tube 264 is a hollow tube that at least partially defines the internal volume 204. The center tube 264 includes one or more holes through a wall of center tube 264 that allow the fluid to pass through. In some embodiments, the center tube 264 is fixedly coupled to the first endplate 210, the second endplate 250, and/or the filter media 260. In other embodiments, the center tube 264 is positioned within the filter media 260 without coupling to the filter media 260. In these embodiments, the center tube 264 may contact the filter media 260 during operation. For example, the filter media 260 may flex or deflect inwards, towards the center tube 264. In some embodiments, the center tube 264 is retained between the first endplate 210 and the second endplate 250 with or without coupling to the first endplate 210 and/or the second endplate 250.

In some embodiments, the filter element 200 includes a coalescing media layer (not shown) disposed radially inside the filter media 260. The coalescing media layer is configured to coalesce and separate water entrained in the fluid.

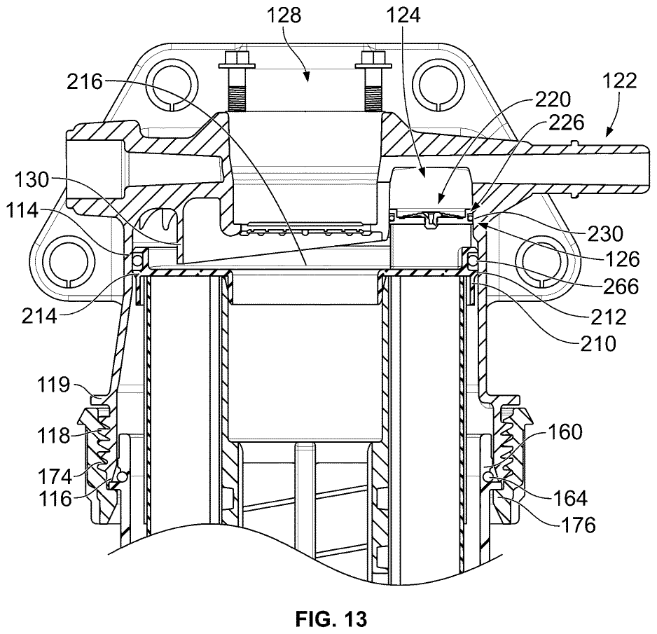

FIG. 13 is a detailed sectional view showing aspects of the filtration system 100 of FIG. 1. The filtration system 100 is shown without the pump 140 in FIG. 13.

In an example embodiment, a method of assembling the filtration system 100 includes providing the filter head 110 and the filter cartridge 150. The method also includes aligning the filter cartridge 150 relative to the filter head 110 such that a portion of the filter cartridge contacts 150 the rib 130. The rib 130 is disposed at a non-zero angle relative to a central axis of the filtration system 100 such that, when the portion of the filter cartridge 150 contacts the rib 130, the rib 130 guides the portion of the filter cartridge towards the valve port 124.

In some embodiments, the valve assembly 220 that extends axially towards the filter head 110 is the portion of the filter cartridge 150 that contacts the rib 130. In this way, the rib 130 guides the valve assembly 220 towards the valve port 124. In some embodiments, the valve assembly 220 is at least partially received within the valve port 124.

In some embodiments, the collar 170 is coupled (e.g., threadably coupled) to the filter head 110 such that the collar flange 176 engages a portion of the filter cartridge 150 (e.g., the shell flange 158) such that the collar 170 couples the filter cartridge 150 to the filter head 110.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges, relationships, or descriptions provided. Accordingly, these terms should be interpreted as indicating that insubstantial or inconsequential modifications or alterations of the subject matter described and claimed are considered to be within the scope of the disclosure as recited in the appended claims. The terms “coupled,” “attached,” and the like as used herein mean the joining of two members directly to one another. Such joining may be stationary (e.g., permanent) or moveable (e.g., removable or releasable).

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, various parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the concepts presented herein.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A filtration system, comprising:
a filter head comprising:
a filter head body defining a valve port; and
a rib extending away from the filter head body;
a filter cartridge comprising:
a shell; and
a filter element coupled to the shell, the filter element comprising,
a filter media, and
a first endplate coupled to a first end of the filter media, the first endplate comprising:
a first endplate end wall; and
a valve assembly extending axially away from the endplate end wall and towards the filter head, the valve assembly comprising:
a valve; and
a valve assembly body defining one or more flow channels, the one or more flow channels enabling fluid communication between the valve port and an inner volume of the filtration system via the valve.

2. The filtration system of claim 1, wherein the rib extends along a rib axis, the rib axis at a non-zero angle relative to a center axis of the filtration system.

3. The filtration system of claim 1, wherein the valve assembly comprises a valve assembly sealing surface extending around a periphery of the valve assembly body and extending towards the valve port, the valve assembly sealing surface sized to receive a sealing member such that the sealing member forms a radial seal between the valve assembly and the valve port.

4. The filtration system of claim 1, wherein the first endplate comprises a first endplate sealing surface extends axially away from the first endplate end wall and directed towards the filter head, the first endplate sealing surface sized to receive a sealing member, such that the sealing member forms a radial seal between the filter head and the first endplate.

5. The filtration system of claim 1, wherein:
the shell defines a first shell sealing surface,
the filter head body defines a filter head sealing surface, and
the filtration system further comprising:
a first sealing member configured to engage the first shell sealing surface and the filter head sealing surface so as to form a first seal therebetween.

6. The filtration system of claim 5, wherein the filter cartridge further comprises:
a second endplate, the second endplate comprising:
a second endplate end wall; and
a second endplate sealing surface disposed at an outer periphery of the second endplate end wall, directed towards the shell, and configured to receive a second sealing member therein such that the second sealing member forms a seal between the second endplate sealing surface and the shell.

7. The filtration system of claim 1, wherein the valve assembly is radially offset from a center axis of the filtration system.

8. The filtration system of claim 1, wherein the filter head further comprises:
a first port in fluid receiving communication with an upstream device and in fluid providing communication with an interior of the filtration system; and
a second port in fluid receiving communication with the interior of the filtration system and in fluid providing communication with a downstream device.

9. The filtration system of claim 8, wherein the valve port is in fluid receiving communication with the interior of the filtration system and in fluid providing communication with the second port.

10. The filtration system of claim 8, further comprising:
a wrapping layer disposed around a portion of the filter media and proximate the first port, the wrapping layer substantially preventing a fluid from flowing therethrough.

11. A filter cartridge comprising:
a shell; and
a filter element positioned within the shell, the filter element comprising:
a filter media; and
a first endplate coupled to a first end of the filter media, the first endplate comprising:
a first endplate end wall; and
a valve assembly extending axially away from the endplate end wall and towards the filter head, the valve assembly comprising:
a valve; and
a valve assembly body defining one or more flow channels, the one or more flow channels enabling fluid communication between the valve port and an inner volume of the filtration system via the valve.

12. The filter cartridge of claim 11, wherein the valve assembly further comprises:
a valve assembly sealing surface extending around a periphery of the valve assembly body, the valve assembly sealing surface sized to receive a sealing member such that the sealing member engages the valve assembly.

13. The filter cartridge of claim 12, wherein the valve assembly sealing surface comprises:
a channel that extends axially away from a top surface of the valve assembly body and defines an open end that is directed radially outward, the channel sized to receive the sealing member therein.

14. The filter cartridge of claim 11, wherein the first endplate further comprises:
a first endplate sealing surface extends axially away from the first endplate end wall and directed towards the filter head, the first endplate sealing surface sized to receive a sealing member, such that the sealing member forms a radial seal between the filter head and the first endplate.

15. The filter cartridge of claim 14, wherein the first endplate sealing surface comprises:
a channel that extends axially away from a top surface of the first endplate end wall, the channel defining an open end directed radially outwards, the channel sized to receive the sealing member.

16. The filter cartridge of claim 11, further comprising:
a second endplate, the second endplate comprising:
a second endplate end wall and a second endplate sealing surface,
the second endplate sealing surface disposed at an outer periphery of the second endplate end wall and directed towards the shell,
wherein the second endplate sealing surface is configured to receive a sealing member therein such that the sealing member forms a seal between the second endplate sealing surface and the shell.

17. The filter cartridge of claim 16, wherein the second endplate sealing surface comprises:
a channel that extends axially away from a bottom surface of the second endplate end wall, the channel defining an open end directed radially outward towards the shell, the channel sized to receive the sealing member.

18. The filter cartridge of claim 11, wherein the valve assembly is radially offset from a center axis of the filter cartridge.

19. A method of assembling a filtration system, comprising:
aligning a filter cartridge relative to a filter head comprising a filter head body defining a valve port and a rib such that a portion of the filter cartridge contacts the rib, the rib guiding the portion of the filter cartridge towards the valve port when the portion of the filter cartridge contacts the rib.

20. The method of claim 19, further comprising:
coupling a collar to the filter head such that a collar flange engages a portion of the filter cartridge to couple the filter cartridge to the filter head.
